(19) United States
(12) Patent Application Publication
(10) Pub. No.: US 2021/0009266 A1
(43) Pub. Date: Jan. 14, 2021

(54) UNMANNED AERIAL VEHICLE PATROL SYSTEM AND UNMANNED AERIAL VEHICLE PATROL METHOD

(71) Applicant: Coretronic Corporation, Hsin-Chu (TW)

(72) Inventors: Kuo-Chang Lee, Hsin-Chu (TW); Chih-Neng Tseng, Hsin-Chu (TW); Cheng-Shen Lee, Hsin-Chu (TW)

(73) Assignee: Coretronic Corporation, Hsin-Chu (TW)

(21) Appl. No.: 16/924,225

(22) Filed: Jul. 9, 2020

(30) Foreign Application Priority Data
Jul. 10, 2019 (CN) 201910619742.5

(51) Int. Cl. B64C 39/02; G05D 1/10

(52) U.S. Cl. CPC B64C 39/024; B64C 2201/145; B64C 2201/127; G05D 1/101

(57) ABSTRACT

A UAV patrol system and a UAV patrol method are provided. A UAV receives a patrol instruction from a base station to perform a patrol task to the target area. The patrol task includes: flying along a cruise path in a first height, and acquiring a first thermal sensing image in a first FOV; in response to determining that the first thermal sensing image has a abnormal point with a temperature higher than a temperature threshold and located on one of multiple object targets, suspending flying along the cruise path and changing to fly in the second height to capture an abnormal image of the abnormal point in a second FOV, and storing and marking the abnormal image. The UAV patrol system and method may effectively use the UAV to determine the abnormal target object in the target area, and capture the abnormal image of the target object.

### CROSS-REFERENCE TO RELATED APPLICATION

This application claims the priority benefit of China application serial no. 201910619742.5, filed on Jul. 10, 2019. The entirety of the above-mentioned patent application is hereby incorporated by reference herein and made a part of this specification.

### BACKGROUND

### Technical Field

The disclosure relates to a patrol system, and particularly relates to an Unmanned Aerial Vehicle (UAV) patrol system and a UAV patrol method.

### Description of Related Art

Solar modules (solar panels), the most important power generation components of a solar power plant, occasionally have structural deterioration or surface contamination/shielding occurred in a local area of the solar modules, which makes the local area unable to maintain power generation characteristics and even turn to power consumption characteristics. Therefore, the local area of the solar modules with power consumption characteristics will start to generate high temperature to cause damage (also known as a hot spot phenomenon).

Conventionally, in order to check whether the solar modules have the hot spot phenomenon, a manual inspection method is adopted, and a detector uses a thermal imager to detect each solar module to determine whether there is the hot spot phenomenon on each solar module.

However, for solar power plants with thousands of solar modules, the above conventional method will consume a lot of time and manpower, resulting in an increase in maintenance cost of the solar power plants. Therefore, how to detect the multiple solar modules more efficiently in the solar power plants is the focus of attention of relevant personnel in this field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure is directed to a UAV patrol system and a UAV patrol method, where a UAV is effectively used to perform a patrol operation on a target area to determine an abnormal target object in the target area, and correspondingly capture an abnormal image of the target object.

In order to achieve one or a portion of or all of the objects or other objects, an embodiment of the disclosure provides a UAV patrol system for patrolling a target area, where the target area includes a plurality of target objects. The UAV patrol system includes a base station and a UAV. The UAV has a positioning device. The positioning device is used for receiving a global positioning system signal to identify a coordinate position of the UAV. The UAV receives a patrol instruction from the base station to perform a patrol task to the target area. In the patrol task, the UAV acquires a first thermal sensing image from the target area in a first field of view according to a cruise path, where the UAV determines whether there is an abnormal point in the first thermal sensing image, and in response to determining that there is the abnormal point in the first thermal sensing image, the UAV suspends its flight in the cruise path, and captures an abnormal image of the abnormal point in a second field of view, and stores and marks the abnormal image.

In order to achieve one or a portion of or all of the objects or other objects, an embodiment of the disclosure provides a UAV patrol method adapted to a UAV system for patrolling a target area, where the UAV patrol system includes a base station and a UAV, and the target area includes a plurality of target objects. The UAV patrol method includes: receiving a global positioning system signal by using the UAV to continuously identify a coordinate position of the UAV; receiving a patrol instruction from the base station of the UAV patrol system by using the UAV to perform a patrol task to the target area, and the patrol task includes: acquiring a first thermal sensing image from the target area in a first field of view according to a cruise path; determining whether there is an abnormal point in the first thermal sensing image; and in response to determining that there is the abnormal point in the first thermal sensing image by using the UAV, the UAV suspends its flight in the cruise path, and captures an abnormal image of the abnormal point in a second field of view, and stores and marks the abnormal image.

Based on the above description, the embodiments of the disclosure provide a UAV patrol system and a UAV patrol method thereof, and the UAV automatically performs the patrol task to the target area according to the patrol instruction received from the base station, and moves on the target area in the first field of view, and acquires the thermal sensing image in the first field of view, so as to determine whether there is an abnormal point in the thermal sensing image, and when it is determined that there is the abnormal point in the thermal sensing image, the UAV captures the abnormal image of the abnormal point in a second field of view. In this way, one or a plurality of abnormal target objects on the target area may be effectively discovered, so as to enhance security of all of the target objects on the target area.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a UAV patrol system and a corresponding target area according to an embodiment of the disclosure.

FIG. 2 is a block schematic diagram of a UAV patrol system according to an embodiment of the disclosure.

FIG. 3A is a flowchart illustrating a UAV patrol method according to an embodiment of the disclosure.

FIG. 3B is a flowchart illustrating a method of capturing an abnormal image corresponding to an abnormal region according to another embodiment of the disclosure.

FIG. 4A is a schematic diagram of a target area and a cruise path corresponding to a first field of view according to an embodiment of the disclosure.

FIG. 4B is a schematic diagram of a target area and a cruise path corresponding to another first field of view according to an embodiment of the disclosure.

FIG. 4C is a schematic diagram of a target area and a specific cruise path according to an embodiment of the disclosure.

FIG. 5 is a schematic diagram of capturing an abnormal image according to an embodiment of the disclosure.

FIG. 6 is a schematic diagram of an abnormal point in a captured thermal sensing image according to an embodiment of the disclosure.

### DESCRIPTION OF THE EMBODIMENTS

It is to be understood that other embodiment may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

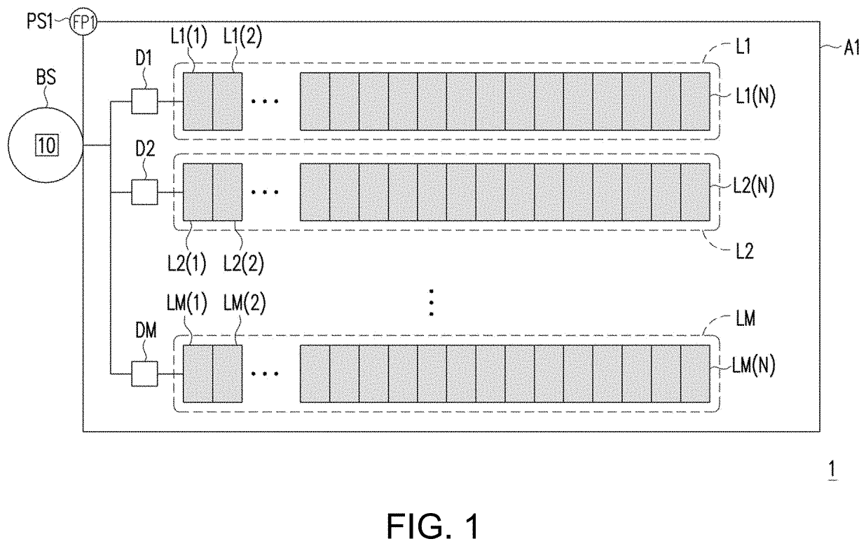

FIG. 1 is a schematic diagram of a UAV patrol system 1 and a corresponding target area A1 according to an embodiment of the disclosure. Referring to FIG. 1, the UAV patrol system 1 includes a base station BS and a UAV 10. The base station BS may send a patrol instruction to the UAV 10, where the patrol instruction is configured to instruct the UAV 10 to execute a patrol operation on the target area A1, so as to inspect whether a plurality of target objects in the target area A1 is abnormal. In the embodiment, the UAV 10 is initially docked at the base station BS, and during the period when the UAV 10 is docked at the base station BS, the base station BS may charge the UAV 10. In an embodiment, the UAV patrol system 1 may further includes a central control system, and the central control system is, for example, a remote server or a remotely connected handheld device, which simultaneously connects the base station BS and the UAV 10 to receive image information or measurement information thereof. In an embodiment, the UAV patrol system 1 may configure the central control system separately from or together with the base station BS, which is not limited by the disclosure.

In the embodiment, FIG. 1 is, for example, a top view of the target area A1. The target area A1 is, for example, a region of a solar power generation system having a plurality of solar modules, where the solar modules are power generation modules including solar films or solar panels, which may also be referred to as solar cells. The solar power generation system has M solar module series L1-LM (a target object group), wherein each solar module series is composed of a plurality of solar panels arranged in series so that each solar panel may receive sunlight to generate and output current. For example, the solar module series L1 is composed of N solar panels L1(1)-L1(N) arranged in series; the solar module series L2 is composed of N solar panels L2(1)-L2(N) arranged in series; and the solar module series LM is composed of N solar panels LM(1)-LM(N) arranged in series, where M and N are positive integers. The total number of the solar module series in the solar power generation system is not limited by the disclosure, and the total number of the solar panels in each solar module series is not limited by the disclosure. Moreover, the total number of the solar panels in each solar module series may be the same or different.

The solar module series L1-LM are respectively coupled to inverters D1-DM to input generated DC currents into the inverters D1-DM. The inverters D1-DM convert the input DC currents into AC currents, and output the converted AC current through a power grid. In an embodiment, the inverters D1-DM (which are also referred to as detectors) may also determine whether the solar module series corresponding to the received DC currents are abnormal according to power information (for example, related information of current, voltage, etc.) of the received DC currents.

In the embodiment, the inverters D1-DM are connected to the base station BS or the central control system to output an abnormal notification and abnormal information corresponding to the abnormal notification. The abnormal notification is used for indicating that the corresponding solar module series (which is also referred to as a specific target area) has abnormity. The abnormal information may include related information such as an identification code of the corresponding solar module series or/and a type of the abnormity, etc. For example, when the inverter D1 of the solar module series L1 determines that the solar module series L1 has the abnormity, the inverter D1 may send the abnormal notification and the abnormal information corresponding to the abnormal notification to the base station BS. In the embodiment, the inverters D1-DM may be connected to the base station BS in a wired, wireless or remote manner to implement data transmission, but the disclosure is not limited thereto. In an embodiment, the inverters D1-DM may also be connected to the central control system.

In the above embodiment, the inverters are configured to convert the DC current/currents generated by one or a plurality of solar module series into the AC current/currents, and the inverters may send the abnormal notifications according to the power information of the received DC currents to indicate that the connected plurality of solar module series have anomalies. In an embodiment, the inverters in the solar power generation system are not in charge of sending the abnormal notifications, but the base station BS may have a plurality of detectors, where the plurality of detectors may determine whether the corresponding solar module series has abnormity according to the AC currents coming from the plurality of inverters and received by the base station BS.

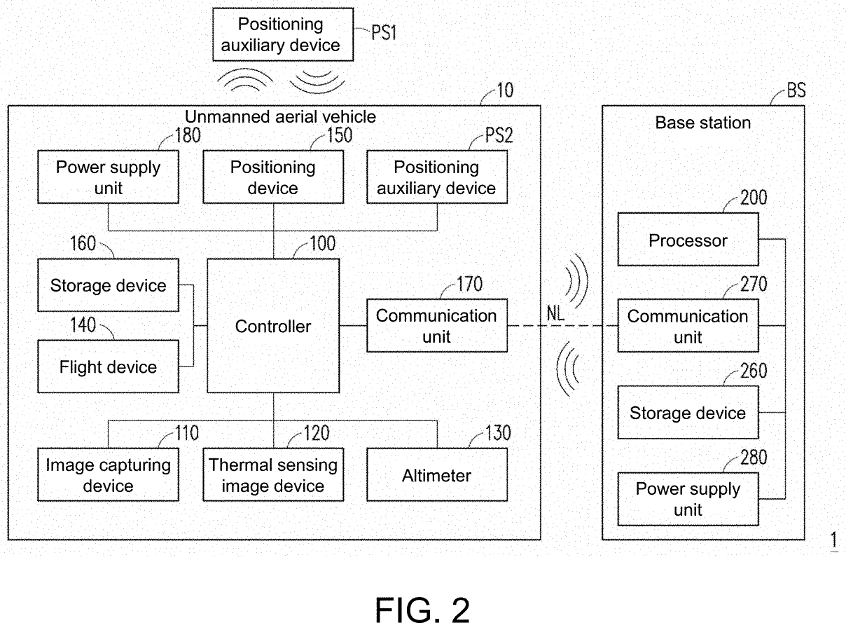

FIG. 2 is a block schematic diagram of a UAV patrol system according to an embodiment of the disclosure. Referring to FIG. 2, the UAV patrol system 1 includes the UAV 10 and the base station BS, and the UAV patrol system 1 further includes a positioning auxiliary device PS1 (which is also referred to as a first positioning auxiliary device), which is disposed at a positioning point FP1 in the target area A1 or disposed on the base station BS. The base station BS includes a processor 200 and a communication unit 270, a storage device 260 and a power supply unit 280 connected to the processor 200.

The UAV 10 includes a controller 100, an image capturing device 110, a thermal sensing image device 120, an altimeter 130, a flight device 140, a positioning device 150, a storage device 160, a communication unit 170, a power supply unit 180 and a positioning auxiliary device PS2 (which is also referred to as a second positioning auxiliary device).

The image capturing device 110 and the thermal sensing image device 120 are configured to capture an image (for example, a RGB image or an optical image) and a thermal sensing image of the target area of the UAV 10. In an embodiment, the image capturing device 110 and the thermal sensing image device 120, for example, take photographs on the area below the UAV 10, so that when the UAV 10 flies over the target area A1, the UAV 10 captures an image (a RGB image) and a thermal sensing image from a part of the target area below the UAV 10. In an embodiment, the image capturing device 110 and the thermal sensing image device 120 may include a lens shooting adjustment device to adjust a shooting angle of the lens.

In the embodiment, the controller 100 is hardware with computing power. The controller 100 is configured to execute one or a plurality of program codes to manage a whole operation of the UAV 10. In the embodiment, the controller 100 is, for example, a Central Processing Unit (CPU), a micro-processor, a Digital Signal Processor (DSP), an Application Specific Integrated Circuits (ASIC), a Programmable Logic Device (PLD) or other similar device with one core or multiple cores. Similar to the controller 100, the processor 200 is also hardware with computing power. The processor 200 is configured to execute one or a plurality of program codes to manage a whole operation of the base station BS.

The communication unit 170 and the communication unit 270 are configured to transmit or receive data through wireless communication, where the communication unit 170 and the communication unit 270 may establish a network connection NL there between, so that the controller 100 and the processor 200 may transmit data or instructions to each other through the established network connection NL. For example, the communication units 170 and 270 may respectively have a wireless communication module (not shown), and support one of a Global System for Mobile communication (GSM) system, a Personal Handy-phone System (PHS), a Code Division Multiple Access (CDMA) system, a Wireless Fidelity (WiFi) system, a Worldwide Interoperability for Microwave Access (WiMAX) system, a 3^{rd} generation wireless communication technology (3G), a fourth generation wireless communication technology (4G), a fifth generation wireless communication technology (5G), a Long Term Evolution (LTE) technology, a Bluetooth communication technology, or a combination thereof, but the disclosure is not limited thereto.

The image capturing device 110 is configured to capture a static image or dynamic images (which are also referred to as a video), and receives an instruction of the controller 100 to capture the image (which is also referred to as a RGB image or an optical image). For example, the image capturing device 110 is, for example, a camera including a lens, a photosensing element and an aperture, etc. The lens is, for example, a standard lens, a wide-angle lens, a zoom lens, etc. The photosensing element is, for example, a Charge Coupled Device (CCD), a Complementary Metal-Oxide Semiconductor (CMOS) element or other element. The lens and the photosensing element or a combination thereof is not limited by the disclosure.

The thermal sensing image device 120 is a device for sensitizing a thermal radiation emitted by an object, so as to output a thermal sensing image. The thermal sensing image device 120 is, for example, a thermal sensing camera. The thermal sensing image may be formed by drawing temperature distribution maps corresponding to different thermal radiation intensities through colors corresponding to different temperatures according to the intensities of thermal radiations emitted by different detected objects. The higher the thermal radiation intensity of the object is, the higher the corresponding sensed temperature is, and the thermal sensing image device 120 draws the region of the object corresponding to the higher thermal radiation in the thermal sensing image with a color corresponding to the higher temperature (for example, a lighter color). In other words, the controller 100, the base station BS or the central control system may determine regions or positions with a higher temperature in the thermal sensing image according to the drawn thermal sensing image.

The altimeter 130 is configured to detect a height (or referred to as an altitude) of the UAV 10, so as to transmit the detected corresponding height value to the controller 100. The altimeter 130 is, for example, a device that obtains the altitude by measuring an atmospheric pressure. The altimeter 130 is, for example, a barometric altimeter, an acoustic altimeter, or a radar altimeter for measuring height information of the UAV 10.

The flight device 140 is configured to receive an instruction from the controller 100 to instruct the UAV 10 to move or fly in a Three-Dimensional (3D) space. The controller 100 may control the flight device 140 to position the UAV 10 in the 3D space, or head for any position in the 3D space. The flight device 140 includes at least one rotor shaft, and electric motors provide multi-directional kinetic energy to the rotor shafts to make the UAV 10 to move or position. The disclosure is not limited to the flight device, and any device that enables the UAV 10 to fly or move does not depart from the scope of the disclosure.

The positioning device 150 is, for example, a Global Positioning System (GPS) device configured to receive global positioning signals of the GPS, so as to position a current coordinate position of the UAV 10. In the embodiment, the positioning device 150 may continuously send identified positioning information (i.e. the current coordinate position of the UAV 10) to the controller 100.

The storage devices 160 and 260 are configured to record task-related data through the instructions of the controller 100 and the processor 200. The storage device 160, for example, records information used for performing patrol tasks/specific patrol tasks (for example, an abnormal point determination mechanism, map information corresponding to the target area); and a plurality of databases (for example, an image recognition database, a thermal sensing image database, an optical image database). The image recognition database is configured to store images or/and image recognition models corresponding to abnormal regions of a plurality of solar modules. The controller 100 may execute an image recognition operation based on the image recognition database, for example, the storage device 160 stores an thermal sensing image database and an optical image database (RGB image database), and the thermal sensing image database may be used for storing a plurality of captured thermal sensing images, and the optical image database is used for storing a plurality of captured static images or dynamic images. The storage device 160 may include any type of non-volatile/volatile memory storage device. In an embodiment, the storage device 260, for example, stores data received by the base station BS (for example, image data corresponding to abnormal images or preserved images), and stores the firmware or software used for controlling the base station BS.

The power supply unit 180 is configured to provide and manage the power of the UAV 10. The power supply unit 180 further includes a battery. The power supply unit 180 may receive power from the outside in a wired or wireless manner to charge the battery.

Similarly, the power supply unit 280 is configured to provide and manage the power of the base station BS. The power supply unit 280 may receive external power (for example, supply mains). Moreover, the power supply unit 280 may also have a battery. In the embodiment, the power supply unit 280 may include a charging module so that when the UAV 10 is docked at the base station BS, the charging module of the power supply unit 280 may transmit power to the power supply unit 180 in a wired or wireless manner.

In an embodiment, the positioning device 150 receives a GPS signal through the second positioning auxiliary device PS2. The first positioning auxiliary device PS1 itself may receive the GPS signal (which is also referred to as a local positioning signal), and the first positioning auxiliary device PS1 may transmit the local positioning signal to the positioning device 150 through the network connection NL. The positioning device 150 may calculate and identify the current coordinate position of the UAV 10 more precisely according to the coordinate position of the first positioning auxiliary device PS1 (i.e., coordinates of the positioning point FP1) and the received GPS signal and the local positioning signal. To be specific, the positioning device 150 may use a Real Time Kinematic (RTK) technology to perform a RTK processing according to the coordinate position of the first positioning auxiliary device PS1 (i.e., the coordinates of the positioning point FP1), the GPS signal received by the second positioning auxiliary device PS2 and the local positioning signal, so as to obtain a centimeter-level positioning result. For example, the first positioning auxiliary device PS1 may correspond to a fixing terminal of the RTK technology, and the second positioning auxiliary device PS2 may correspond to a mobile terminal of the RTK technology. The positioning result represents a precise coordinate position of the UAV10. The RTK technology is a well-known technical means to those skilled in the art, so that details thereof are not repeated. In an embodiment, the first positioning auxiliary device PS1 may be disposed at any position in the target area A1 (shown in FIG. 1) or disposed on the base station BS.

In the embodiment, the controller 100 may identify a current position of the UAV 10 in the target area A1 according to the current coordinate position of the UAV 10, the coordinate position of the positioning point FP1 and map information of the target area A1. In an embodiment, the controller 100 may further assist in determining the current position of the UAV 10 in the target area A1 according to perspectives of the images captured by the image capturing device 110 and the thermal sensing image device 120.

In the embodiment, the UAV 10 may execute a target area mapping operation. In the target area mapping operation, the UAV 10 may patrol the target area A1, and position a target object coordinate position of each of the target objects according to the GPS signal and the local positioning signal. To be specific, the UAV 10 may fly to the top of a center point of each of the target objects according to the map information of the target area A1, and take the current coordinate position of the UAV 10 as the target object coordinate position of each of the target objects, so as to complete positioning the coordinate position of each of the target objects.

Then, the UAV 10 may map a plurality of identification codes corresponding to the plurality of target objects in the map information to the plurality of target object coordinate positions according to the map information of the target area A1 and the plurality of target object coordinate positions of the target objects. To be specific, each time when positioning of one target object is completed to obtain the target object coordinate position of the target object (now, the UAV 10 is located above the center point of the target object), the UAV 10 may identify the identification code of the target object, and map the identification code to the positioned target object coordinate position. In an embodiment, the UAV 10 may map a coordinate value of any point in the target object to the identification code of the target object according to a size of the target object and the target object coordinate position corresponding to the center point of the target object. In other words, the UAV 10 may map an arbitrary point in the target object to the identification code of the target object.

It should be noted that operations of each of the components of the UAV 10 and the base station BS may be regarded as a whole operation of the UAV 10 and the base station BS.

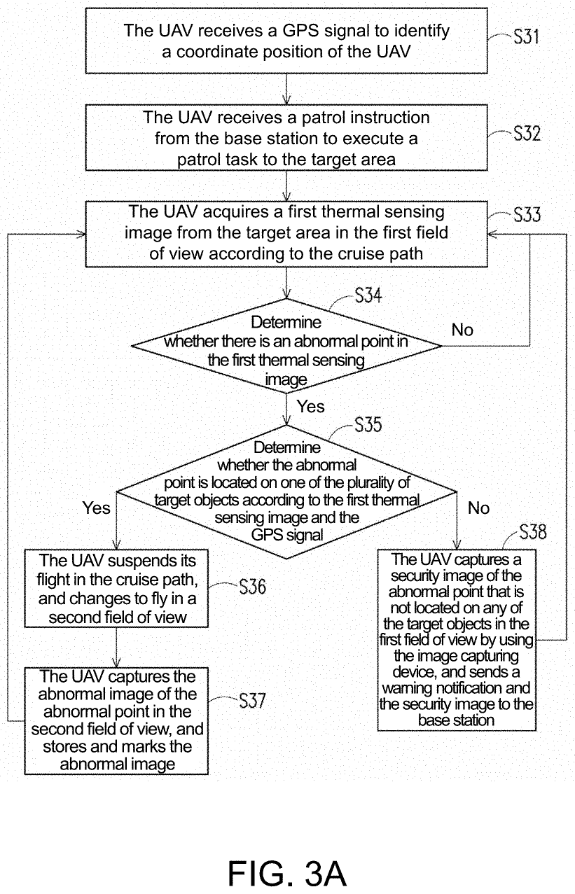

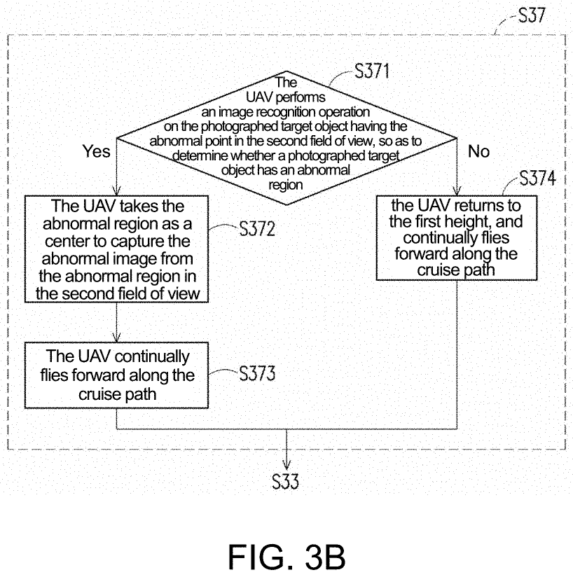

FIG. 3A is a flowchart illustrating a UAV patrol method according to an embodiment of the disclosure. Referring to FIG. 3A, in a step S31, the UAV 10 receives a GPS signal to identify the coordinate position of the UAV 10. It should be noted that the step S31 may be periodically executed, i.e. the controller 100 may periodically identify the current coordinate position of the UAV 10. For example, every a predetermined time, the UAV 10 identify the current coordinate position according to the received GPS signal. Moreover, the coordinate position may be a precise coordinate position, i.e. the coordinate position of the UAV 10 obtained through the RTK technology.

Then, in a step S32, the UAV 10 receives a patrol instruction from the base station BS to execute a patrol task to the target area A1. The processor 200 may periodically send the patrol instruction to make the UAV 10 to periodically execute the patrol task. In an embodiment, the patrol instruction may include one or a plurality of following information: (1) the map information corresponding to the target area A1; (2) a plurality of coordinate values corresponding to a cruise path of the patrol task; (3) a height (which is also referred to as a first height or a cruise height) corresponding to the cruise path of the patrol task; (4) a height (which is also referred to as a second height or an image capturing height) used for capturing abnormal images; (5) a size of a field of view (which is also referred to as a first field of view) of the UAV 10 (the image capturing device 110 or the thermal sensing image device 120) when the UAV 10 flies at the cruise height; and (6) a total number of the target objects included in the first field of view of the UAV 10 (the image capturing device 110 or the thermal sensing image device 120) when the UAV 10 flies at the cruise height.

It should be noted that the sequence that the UAV patrol system 1 executes the step S31 and the step S32 may be adjusted according to an actual situation. For example, if the UAV 10 is parked at the base station BS and is in a shutdown state, when a regular or unexpected patrol task is to be carried out, the UAV 10 is first turned on or switched from a standby state to a usable state, and executes the step S32 to receive the patrol instruction to execute the patrol task to the target area, and then executes the step S31 to receive the GPS signal to continuously identify the coordinate position of the UAV 10.

Then, in a step S33, the UAV 10 acquires a first thermal sensing image from the target area in the first field of view according to the cruise path. To be specific, in an embodiment, the controller 100 or the processor 200 may plan the cruise path according to one or more of a variety of information. The variety of information includes: (1) map information of the target area A1, which includes a plurality of identification codes corresponding to a plurality of target objects of the patrol task, and the coordinate position of the positioning point FP1; (2) a specification (for example, a lens focal length, a size of a photosensing element, an area of the photosensing element) of the image capturing device 110 (or the thermal sensing image device 120); (3) a size of the solar module; (4) a spacing between adjacent solar modules; (5) a height value of the cruise height; and (6) a size of the field of view (the first field of view) corresponding to the cruise path. When the cruise path has been planned in advance (for example, planned by the processor 200 in advance), coordinate information of the pre-planned cruise path may be transmitted to the UAV 10, and the UAV 10 may use the planned cruise path to execute the patrol task.

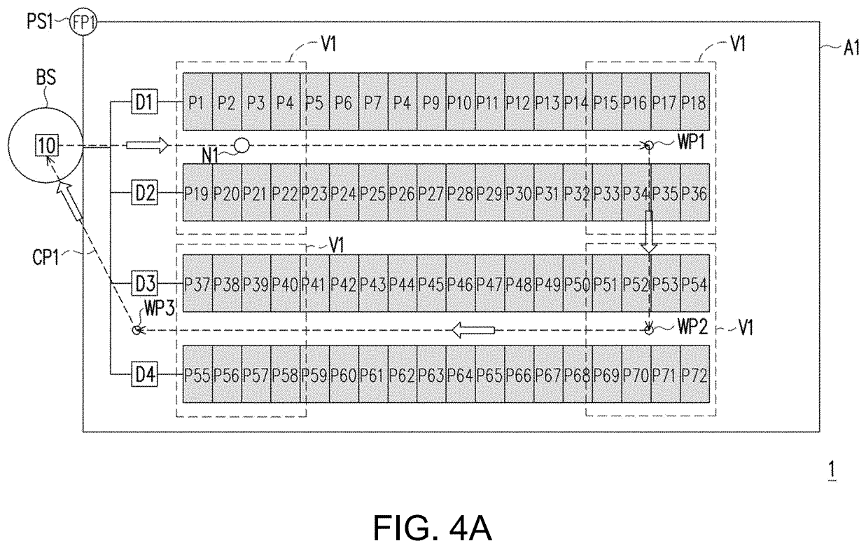

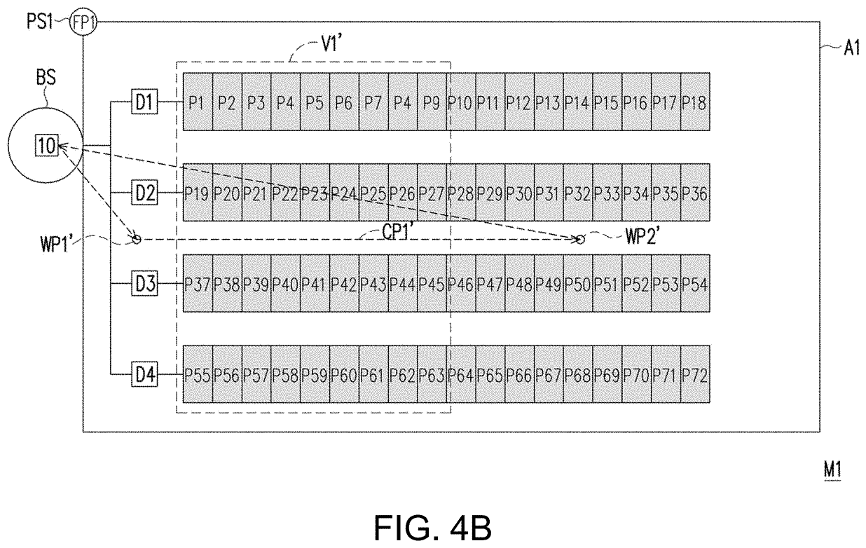

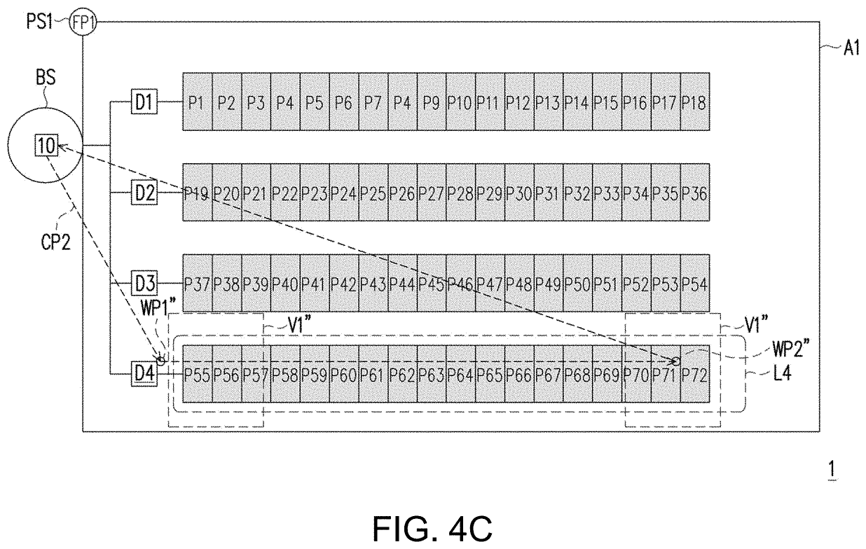

Referring to FIG. 4A-FIG. 4C, FIG. 4A-FIG. 4C are similar to FIG. 1, and for simplicity's sake, it is assumed that M is equal to 4, N is equal to 18, and the corresponding plurality of target objects are shown in FIG. 4A-FIG. 4C. Moreover, it is assumed that the identification codes corresponding to the target object L1(1)-L1(18) are “P1”-“P18”; the identification codes corresponding to the target object L2(1)-L2(18) are “P19”-“P36”; the identification codes corresponding to the target object L3(1)-L3(18) are “P37”-“P54”; and the identification codes corresponding to the target object L4(1)-L4(18) are “P55”-“P72”. The map information of the target area A1 at least records the base station BS, the positioning point FP1, the target area A1, the 72 target objects in the target area A1 and the corresponding identification codes P1-P72.

FIG. 4A is a schematic diagram of the target area A1 and a cruise path CP1 corresponding to the first field of view according to an embodiment of the disclosure. Referring to FIG. 4A, for example, it is assumed that the base station BS sends the patrol instruction to the UAV 10, the patrol instruction instructs the UAV 10 to execute the patrol task to the target area A1 and fly along the cruise path CP1 in the first field of view V1. The first field of view V1 may accommodate 8 target objects at most. The controller 100 may calculate a height (i.e. the first height) of the cruise path according to the above information, and plan the cruise path CP1. As shown in FIG. 4A, coordinates of a start point and an end point of the cruise path CP1 are the coordinates of the base station BS, and the cruise path CP1 includes coordinates of way points WP1-WP3. When the UAV 10 uses the first field of view V1 to fly along the cruise path CP1 and returns to the base station BS, the UAV 10 may complete scanning all of the target objects P1-P72. It should be noted that the disclosure is not limited to the above method for planning the cruise path. The above example for explaining the planning method of the cruise path is exemplary, which is not used for limiting the disclosure. According to the information used to plan the cruise path (for example, the size of the first field of view V1 and the total number of the target objects contained in the first field of view V1), the planned cruise path will also be different.

In another embodiment, the information used for planning the cruise path is different from that of the cruise path of FIG. 4A, so that the planned cruise path is different. FIG. 4B is a schematic diagram of the target area A1 and a cruise path CP1′ corresponding to another first field of view according to an embodiment of the disclosure. Referring to FIG. 4B, for example, it is assumed that the base station BS sends the patrol instruction to the UAV 10, the patrol instruction instructs the UAV 10 to execute the patrol task to the target area A1 and fly along the cruise path CP1′ in the first field of view V1′. The first field of view V1′ may accommodate 36 target objects at most. The controller 100 may calculate a height (i.e. the first height) of the cruise path according to the above information, and plan the cruise path CP1′. For example, coordinates of a start point and an end point of the cruise path CP1′ are the coordinates of the base station BS, and the cruise path CP1′ includes coordinates of way points WP1′-WP2′. It should be noted that in the above example, the first height corresponding to the first field of view V1′ should be greater than the first height corresponding to the first field of view V1.

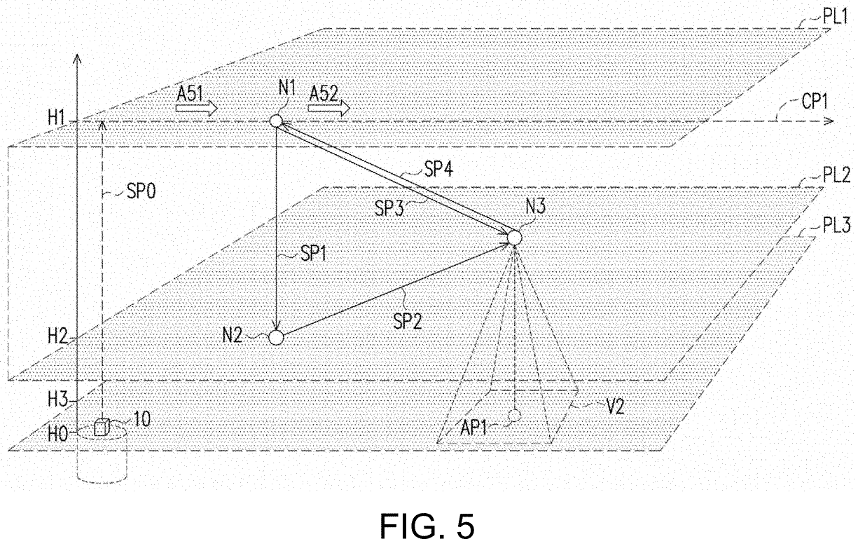

FIG. 5 is a schematic diagram of capturing an abnormal image according to an embodiment of the disclosure. Referring to FIG. 3 to FIG. 5, when the UAV 10 starts to execute the patrol task, the UAV 10 may depart from the base station BS, and the UAV 10 first rises to a first height H1. Then, the UAV 10 flies forward along the cruise path CP1 (as indicated by an arrow A51), and meanwhile the thermal sensing image device 120 acquires a thermal sensing image (which is also referred to as the first thermal sensing image) from the target area A1 in the first field of view V1.

Each time when one thermal sensing image is acquired, the controller 100 (or the processor 200) may execute a step S34, i.e. to determine whether there is an abnormal point in the first thermal sensing image. In other words, when the UAV 10 flies along the cruise path CP1, the UAV 10 may continuously acquire the thermal sensing images, and determine whether there is an abnormal point in the acquired thermal sensing images. In an embodiment, regarding determination of the abnormal point, the UAV 10 may determine that the first thermal sensing image has an abnormal point when a thermal image block in the first thermal sensing image has a temperature difference with the surrounding temperature (for example, a thermal image block having a significant temperature difference from the surrounding).

To be more specific, when each solar module (i.e. the target object) accumulates heat energy in an abnormal region of the solar module due to various factors, a converted current cannot pass through the abnormal region. Namely, in the solar module, a temperature of the abnormal region will be higher than temperatures in other regions where DC currents may be generated, and the abnormal region may be discovered to have the thermal image block with a temperature difference from the surrounding area in the first thermal sensing image (for example, the thermal image block with obvious temperature difference from the surrounding area), so that the first thermal sensing image is determined to have the abnormal point.

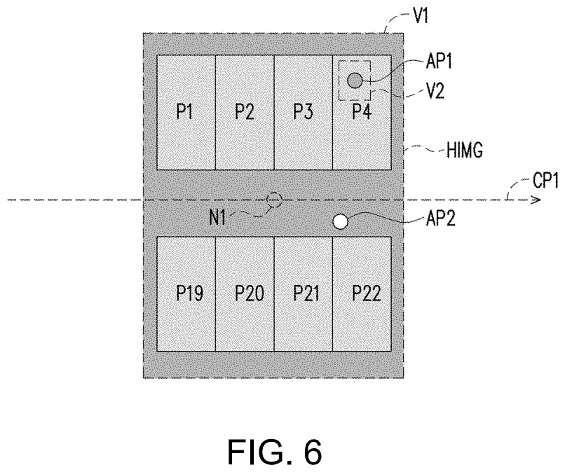

FIG. 6 is a schematic diagram of an abnormal point in the captured thermal sensing image according to an embodiment of the disclosure. Referring to FIG. 4A and FIG. 6, for example, it is assumed that when the UAV 10 flies to a point N1, the UAV 10 acquires a thermal sensing image HIMG, and discovers that the solar module P4 has an abnormal point AP1. In this example, the UAV 10 may determine that the first thermal sensing image HIMG includes a thermal image block with a temperature difference from the surrounding area (for example, the thermal image block with obvious temperature difference from the surrounding area) according to the acquired first thermal sensing image HIMG, and accordingly determines that the first thermal sensing image HIMG has the abnormal point AP1. In an embodiment, the UAV 10 may discover that the solar module P4 has a block with a temperature higher than a temperature threshold from the acquired thermal sensing image HIMG, and determine that the first thermal sensing image HIMG has the abnormal point AP1.

Referring back to FIG. 3A, in the step S34, in response to determining that there is the abnormal point in the first thermal sensing image, a step S35 is executed, by which the UAV 10 determines whether the abnormal point is located on one of the plurality of target objects according to the first thermal sensing image and the GPS signal.

To be specific, the UAV 10 identifies a coordinate position of the abnormal point AP1 according to the first thermal sensing image, the GPS signal and the local positioning signal, and compares the coordinate position of the abnormal point AP1 with a plurality of target object coordinate positions to determine whether the abnormal point AP1 is located on one of the plurality of target objects. Namely, the UAV 10 may identify the coordinate position of the abnormal point AP1, and determine whether the abnormal point falls within a range of a target object according to the coordinate position of the abnormal point AP1, the plurality of target object coordinate positions and sizes of the target objects. If yes (for example, it is determined that the abnormal point falls within the range of a certain target object in the plurality of target objects), the UAV 10 determines that the abnormal point is located on one of the plurality of target objects (which are also referred to as a photographed target object).

As shown in FIG. 6, continue with the example above, the UAV 10 may determine whether the abnormal point AP1 falls within the range of the solar module P4 according to the coordinate position of the abnormal point AP1, i.e. to determine that the abnormal point AP1 is located on one of the plurality of target objects. In response to determine that the abnormal point AP1 is located on one of the plurality of target objects (the step S35→yes), the method flow goes to a step S36; and in response to determine that the abnormal point AP1 is not located on any of the target objects (the step S35→no), the method flow goes to a step S38. It should be noted that in an embodiment, the steps S35 and the step S38 may be omitted. Namely, in response to determine that the first thermal sensing image has the abnormal point AP1, the controller 100 executes the step S36. In an embodiment, in response to determine that the abnormal point AP1 is located on one photographed target object in the plurality of target objects, the UAV 10 may identify the identification code of the photographed target object according to the map information of the target area.

Then, in the step S36, the UAV 10 suspends its flight in the cruise path, and changes to fly in a second field of view. To be specific, the UAV 10 stops flying forward along the cruise path, and records current coordinates in the cruise path as suspending point coordinates, and starts to descend to a second height to capture an image in the second field of view. After reaching the second height, the UAV 10 sets off from the suspending point coordinates, and starts to fly to the coordinate position of the abnormal point AP1. In the embodiment, the second field of view V2 is smaller than the first field of view V1, and in order to achieve such effect, the UAV patrol system 1 is not limited to change the height, for example, the UAV 10 may fly at the same height (i.e. the first height), but capture an image in the second field of view V2 by adjusting a focal length of the lens.

For example, if the UAV 10 changes the field of view by means of changing the height, detailed steps thereof are as follows. Referring to FIG. 5, it is assumed that a plane PL1 corresponds to the height H1, a plane PL2 corresponds to a height H2, and a plane PL3 corresponds to a height H3 (the height H3 is, for example, a height of the abnormal point on the photographed target object). Moreover, it is assumed that a plane provided to the UAV 10 by the base station BS for docking has a height H0. At the beginning of the patrol task, the UAV 10 rises from the height H0 to the height H1 (shown as a path SP0), and flies forward along the cruise path CP1 (shown as an arrow A51).

Continue with the above example, when the UAV 10 flies to a point N1 in the plane PL1 with the height H1, the UAV 10 determines that the acquired first thermal sensing image HIMG has the abnormal point AP1, and the abnormal point AP1 is located on a target object with an identification code P4. In this case, the UAV 10 suspends to continue flying forward in the cruise path CP1, and descends to a point N2 in the plane PL2 with the height H2 (shown as a path SP1).

To be specific, when the UAV 10 suspends flying along the cruise path CP1, and wants to fly at the second height, the UAV 10 records the coordinates of the point N1 in the cruise path CP1 as suspending point coordinates. Then, the UAV 10 starts to descend to the point N2 of the height H2 (which is also referred to as the second height), and the UAV 10 sets off from the suspending point coordinates according to the coordinate position of the abnormal point AP1, and starts to fly to a point N3 above the abnormal point AP1 (shown as a path SP2), i.e. the UAV 10 may fly to the coordinate position of the abnormal point AP1. Moreover, the point N2 and the point N3 are all in the plane PL2, or the point N3 may be slightly higher than or slightly lower than the plane PL2, so as to capture a proper abnormal image.

After the UAV 10 flies to the coordinate position of the abnormal point AP1, a step S37 is executed, by which the UAV 10 captures the abnormal image of the abnormal point in the second field of view V2, and stores and marks the abnormal image, where the UAV 10 may capture the abnormal image through the image capturing device 110 and the thermal sensing image device 120. In an embodiment, the UAV 10 may capture the abnormal image only through the image capturing device 110.

Referring to FIG. 5, continue with the above example, it is assumed that the UAV 10 has flied to the point N3. In this case, the UAV 10 may capture the abnormal image through the image capturing device 110 in the second field of view V2 by aiming at the coordinate position of the abnormal point AP1 on the photographed target object P4. Then, the UAV 10 may mark the identification code P4 of the photographed target object to the abnormal image, and the abnormal image marked with the identification code may be stored to the storage device 160. In an embodiment, the abnormal image marked with the identification code may be transmitted to the base station BS through the communication unit 170.

In another embodiment, the UAV 10 may first execute an image recognition operation to determine whether the photographed target object has the abnormal region, and then determine whether to capture the abnormal image corresponding to the abnormal region according to the above determination result.

FIG. 3B is a flowchart illustrating a method of capturing an abnormal image corresponding to an abnormal region according to another embodiment of the disclosure. Referring to FIG. 3B, in a step S371, the UAV 10 performs an image recognition operation on the photographed target object P4 having the abnormal point AP1 in the second field of view V2, so as to determine whether the photographed target object P4 has the abnormal region. In response to determining that the photographed target object P4 has the abnormal region (the step S371→yes), a step S372 is executed; and in response to determining that the photographed target object P4 does not have the abnormal region (the step S371→no), a step S374 is executed. In the step S372, the UAV 10 takes the abnormal region as a center to capture the abnormal image from the abnormal region in the second field of view. In the step S373, the UAV 10 continually flies forward along the cruise path, and the method flow goes to the step S33.

In detail, in the another embodiment, the UAV 10 performs the image recognition operation on the photographed target object P4 having the abnormal point AP1 in the second field of view V2, so as to determine whether the photographed target object P4 has the abnormal region. Namely, after the UAV 10 flies to the coordinate position of the abnormal point AP1, a current field of view of the UAV 10 is the second field of view V2 that is smaller than the first field of view V1, and the controller 100 captures an image in the second field of view V2 by using the image capturing device 110, and executes the image recognition operation on the image.

In the image recognition operation, the controller 100 may use an image recognition database to identify whether the image of a part of the photographed target object P4 in the second field of vision has the abnormal region. For example, if it is identified that the image includes an image corresponding to a damage event, or identified that the image includes an image corresponding to a certain abnormal object, the controller 100 may determine that the image has the abnormal region. The damage event, for example, refers to a rupture of the solar module. The abnormal object is, for example, a bird dropping or a leave covering the solar module, or other object that may block the sunlight. The abnormal region is a region centered on the damage event or the abnormal object.

In response to determining that the photographed target object has the abnormal region, the UAV 10 takes the abnormal region as a center to capture the abnormal image from the abnormal region in the second field of view (the step S372). Then, in a step S373, the UAV 10 stores and marks the abnormal image. Namely, after determining the abnormal region through the image recognition operation, the UAV 10 may store the captured abnormal image of the abnormal region in the second field of view.

Conversely, in response to determining that the photographed target object does not have the abnormal region, the UAV 10 returns to the first height H1 (shown as a path SP4), and continually flies forward along the cruise path (step S374).

After the UAV 10 completes capturing and storing the abnormal image, the method flow goes to the step S33. Namely, after the UAV 10 completes the operations of capturing and storing the abnormal image, the UAV 10 returns to the first height H1 (shown as the path SP4), and flies to the node N1 corresponding to the suspending point coordinates, and continually flies forward along the cruise path CP1 (shown as an arrow A52).

In another embodiment, the path along which the UAV 10 flies to the point N1 corresponding to the suspending point coordinates is a reverse path of the path along which the UAV 10 flies to the point N3. For example, corresponding to a flying path of flying from the suspending point coordinates to the coordinate position of the abnormal point (for example, N1→N2→N3), the UAV 10 may use a reverse path (for example, N3→N2→N1) to fly from the coordinate position of the abnormal point to the suspending point coordinates.

It should be noted that in an embodiment, the UAV 10 may directly fly from the point N1 corresponding to the height H1 to the point N3 corresponding to the height H2 (shown as a path SP3). In an embodiment, the UAV 10 may fly from the point N1 to the coordinate position of the abnormal point at the height H1, and then descend to the point N3 of the height H2, so as to capture the abnormal image centered on the abnormal point AP1 in the second field of view V2.

Referring to FIG. 3A, in the step S38, the UAV 10 captures a security image of the abnormal point that is not located on any of the target objects in the first field of view V1 by using the image capturing device 110, and sends a warning notification and the security image to the base station BS.

For example, referring to FIG. 6, it is assumed that the first thermal sensing image obtained by the UAV 10 has an abnormal point AP2. In this example, the UAV 10 may determine that the abnormal point AP2 is not located on any of the target objects. Then, the controller 100 may instruct the image capturing device 110 to capture an image in the first field of view V1 to serve as the security image by using the image capturing device 110. Then, the UAV 10 sends a warning notification and the security image to the base station BS. The warning notification is used to indicate that the abnormal point AP2 having a higher temperature is presently appeared in the first field of view V1, where the RGB image corresponding to the first field of view V1 may refer to the security image. In this way, the UAV patrol system 1 may also provide the warning notification with a security function, which may warn that the abnormally object with a temperature higher than a temperature threshold value is appeared in the target area A1. Related security personnel may use the security image to view the (aerial photography) image of the corresponding part of the target area A1 to further determine the security of the part of the target area A1. In an embodiment, the UAV 10 may simultaneously use the image capturing device 110 and the thermal sensing image device 120 to capture images in the first field of view V1 to serve as the security image. In an embodiment, the UAV 10 may first analyze the security image captured by the image capturing device 110 and the thermal sensing image device 120 in the first field of view V1, and then determine whether to send the warning notification with the security function. In an embodiment, the UAV 10 may first analyze the security image captured in the first field of view V1 to send a different type of the warning notification such as an anti-theft warning notification.

It should be noted that if the acquired first thermal sensing image simultaneously have the abnormal point AP1 on the photographed target object and the abnormal point AP2 located on none of the target objects, the UAV 10 may first capture an image in the first field of view V1 to serve as the security image, and then suspend flying in the cruise path CP1, and set off to the coordinate position corresponding to the abnormal point AP1 to capture the abnormal image.

Moreover, if the acquired first thermal sensing image has a plurality of abnormal points on one or a plurality of photographed target objects, the UAV 10 may plan a photographing sequence of the abnormal points according to the coordinate positions of the abnormal points, and set off to the corresponding abnormal points to capture the abnormal images according to the photographing sequence. For example, the UAV 10 may determine a plurality of abnormal point distances between the plurality of abnormal points and a current coordinate position of the UAV 10 according to coordinate positions of the plurality of abnormal points, and determine the photographing sequence according to the plurality of abnormal point distances. For example, the abnormal point corresponding to the minimum abnormal point distance has the highest photographing priority, or the abnormal point corresponding to the maximum abnormal point distance has the highest photographing priority. Then, the UAV 10 sets off to the plurality of abnormal points at the second height H2 according to the determined photographing sequence to capture a plurality of abnormal images.

Moreover, in an embodiment, if the acquired first thermal sensing image has a plurality of abnormal points on none of the target objects, the UAV 10 may directly capture a security image of the plurality of abnormal points in the first field of view. After capturing the security image, the method flow goes to the step S33, i.e. the UAV 10 continually flies forward along the cruise path CP1 at the height H1, and continuously acquires corresponding thermal sensing images at different positions in the cruise path CP1.

In the embodiment, when the UAV 10 flies back to the coordinate position of the base station BS along the cruise path CP1, the UAV 10 may determine that the patrol task is completed, and descend and dock to the base station BS. The stored one or a plurality of marked abnormal images may be transmitted to the base station BS, and the base station BS may further inspect the one or plurality of abnormal images. Moreover, the base station BS may execute a corresponding cleaning or maintenance task to the solar modules corresponding to one or a plurality of identification codes according to one or a plurality of identification codes marked on the one or plurality of abnormal images.

It should be noted that the patrol task introduced in the aforementioned embodiments may be periodically executed. However, besides the periodic patrol task, in an embodiment, the controller 100 (or the processor 200) may further plan a specific cruise path. To be specific, as described above, the inverters D1-D4 may respectively include a detector, and when the detector of the inverter D4 of the solar module series L1 determines that the solar module series L4 is abnormal, the detector of the inverter D4 may send an abnormal notification and abnormal information corresponding to the abnormal notification to the base station BS. The base station BS may receive the abnormal notifications from the detectors configured corresponding to a plurality of target objects and the abnormal information corresponding to the abnormal notifications. The base station BS may determine which target objects in the target area A1 are abnormal according to the received abnormal notifications, and send a specific patrol instruction to the UAV 10 to execute a specific patrol task.

FIG. 4C is a schematic diagram of a target area and a specific cruise path according to an embodiment of the disclosure. Referring to FIG. 4C, for example, it is assumed that the detector D4 sends the abnormal notification and the abnormal information to the base station BS, where the abnormal notification indicates that the solar module series L4 corresponding to the detector D4 is abnormal, or the abnormal notification may indicate that a specific target area containing the solar module series L4 is abnormal. The base station BS may recognize the specific target area corresponding to the solar module series L4 from the target area A1 and a coordinate position corresponding to the specific target area according to the abnormal notification and the map information of the target area A1. The base station BS may send a specific patrol instruction to the UAV 10, where the specific patrol instruction indicates the UAV 10 to execute a specific patrol task on the specific target area. The specific patrol instruction may include information of the coordinate position corresponding to the specific target area.

The UAV 10 may plan a specific patrol path CP2 according to the specific patrol instruction, and may execute the specific patrol task according to the specific patrol path CP2. It is assumed that coordinates of a start point and an end point of the specific cruise path CP2 are the coordinates of the base station BS, and the specific cruise path CP2 includes coordinates of way points WP1″-WP2″. The UAV 10 may fly and execute the specific patrol task according to the planned specific patrol path CP2, and meanwhile scan a plurality of target objects P55-P72 corresponding to the specific target area of the solar module series L4 in the first field of view V1″, and the UAV 10 tries to find out the abnormal target objects from the plurality of target objects P55-P72, and correspondingly capture an abnormal image on the found abnormal target objects.

In summary, the embodiments of the disclosure provide a UAV patrol system and a UAV patrol method thereof, and the UAV automatically performs the patrol task to the target area according to the patrol instruction received from the base station, and flies on the target area at the first height, and acquires the thermal sensing image in the first field of view, and the UAV flies to the coordinates of the abnormal point at the second height according to the abnormal point with a temperature higher than a threshold value and located on the target object in the thermal sensing image, so as to capture the abnormal image corresponding to the abnormal point in the second field of view, so that the abnormal image of the abnormal target object is obtained after the UAV completes patrolling the target area. In this way, one or a plurality of target objects with abnormity on the target area may be effectively discovered, so as to increase security of all of the target objects on the target area.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An unmanned aerial vehicle patrol system, configured to patrol a target area, wherein the target area comprises a plurality of target objects, the unmanned aerial vehicle patrol system comprising:
a base station; and
an unmanned aerial vehicle, having a positioning device, and configured to receive a global positioning system signal to identify a coordinate position of the unmanned aerial vehicle, wherein the unmanned aerial vehicle receives a patrol instruction from the base station to perform a patrol task to the target area, and in the patrol task,
the unmanned aerial vehicle acquires a first thermal sensing image from the target area in a first field of view according to a cruise path, wherein the unmanned aerial vehicle determines whether there is an abnormal point in the first thermal sensing image,
wherein in response to determining that there is the abnormal point in the first thermal sensing image, the unmanned aerial vehicle suspends its flight in the cruise path, and captures an abnormal image of the abnormal point in a second field of view, and stores and marks the abnormal image.

2. The unmanned aerial vehicle patrol system as claimed in claim 1, wherein the second field of view is smaller than the first field of view.

3. The unmanned aerial vehicle patrol system as claimed in claim 2, wherein the unmanned aerial vehicle flies along the cruise path at a first height to acquire the first thermal sensing image of the target area in the first field of view, and flies at a second height to capture the abnormal image of the abnormal point in the second field of view, wherein the first height is greater than the second height.

4. The unmanned aerial vehicle patrol system as claimed in claim 1, wherein in response to determining that there is the abnormal point in the first thermal sensing image, the unmanned aerial vehicle determines whether the abnormal point is located on one of the plurality of target objects according to the first thermal sensing image and the global positioning system signal, and in response to determining that the abnormal point is located on one of the plurality of target objects, the unmanned aerial vehicle suspends its flight in the cruise path, and changes to fly at the second height.

5. The unmanned aerial vehicle patrol system as claimed in claim 1, wherein when the unmanned aerial vehicle determines that the first thermal sensing image has a thermal image block having a temperature difference with the surrounding, the unmanned aerial vehicle determines that the first thermal sensing image has the abnormal point.

6. The unmanned aerial vehicle patrol system as claimed in claim 1, wherein the unmanned aerial vehicle comprises an image capturing device, a thermal sensing image device, an altimeter, a communication unit and a controller, wherein
the image capturing device is configured to capture the abnormal image;
the thermal sensing image device is configured to acquire the first thermal sensing image;
the altimeter is configured to identify a height of the unmanned aerial vehicle;
the communication unit is configured to establish a wireless connection with the base station, the unmanned aerial vehicle and the base station transmit the patrol instruction and the abnormal image through the wireless connection; and
the controller is configured to manage the patrol task and execute an image recognition operation.

7. The unmanned aerial vehicle patrol system as claimed in claim 1, wherein the unmanned aerial vehicle patrol system further comprises a first positioning auxiliary device and a second positioning auxiliary device,
wherein the first positioning auxiliary device is fixed to the base station or a positioning point in the target area, and the second positioning auxiliary device is disposed on the unmanned aerial vehicle, and is coupled to the positioning device,
wherein the first positioning auxiliary device transmits a local positioning signal to the positioning device, and the positioning device receives the global positioning system signal through the second positioning auxiliary device,
wherein the positioning device identifies a coordinate position of the unmanned aerial vehicle according to a coordinate position of the first positioning auxiliary device, the global positioning system signal and the local positioning signal.

8. The unmanned aerial vehicle patrol system as claimed in claim 7, wherein the unmanned aerial vehicle patrols the target area, positions a target object coordinate position of each of the plurality of target objects according to the global positioning system signal and the local positioning signal,
the unmanned aerial vehicle maps a plurality of identification codes corresponding to the plurality of target objects in map information to the plurality of target object coordinate positions according to the map information of the target area and the plurality of target object coordinate positions of the plurality of target objects.

9. The unmanned aerial vehicle patrol system as claimed in claim 8, wherein in the patrol task,
the unmanned aerial vehicle identifies a coordinate position of the abnormal point according to the first thermal sensing image, the global positioning system signal and the local positioning signal, and compares the coordinate position of the abnormal point with the plurality of target object coordinate positions to determine whether the abnormal point is located on one of the plurality of target objects.

10. The unmanned aerial vehicle patrol system as claimed in claim 8, wherein in the patrol task,
in response to determining that the abnormal point is located on a photographed target object in the plurality of target objects, the unmanned aerial vehicle identifies an identification code of the photographed target object,
when the unmanned aerial vehicle arrives the coordinate position of the abnormal point and captures the abnormal image of the photographed target object having the abnormal point in the second field of view, the unmanned aerial vehicle marks the identification code of the photographed target object to the abnormal image.

11. The unmanned aerial vehicle patrol system as claimed in claim 4, wherein in response to determining that the abnormal point is located on one of the plurality of target objects, in the patrol task,
the unmanned aerial vehicle suspends flying forward along the cruise path, records current coordinates in the cruise path as suspending point coordinates, and starts descending to the second height,
after arriving the second height, the unmanned aerial vehicle sets off from the suspending point coordinates, and starts flying to the coordinate position of the abnormal point.

12. The unmanned aerial vehicle patrol system as claimed in claim 11, wherein in response to completion of the operation of storing and marking the abnormal image, in the patrol task,
the unmanned aerial vehicle returns to the first height, flies to the suspending point coordinates, and continually flies forward along the cruise path.

13. The unmanned aerial vehicle patrol system as claimed in claim 1, wherein in the operation of capturing the abnormal image of the abnormal point in the second field of view,
the unmanned aerial vehicle performs an image recognition operation on a photographed target object having the abnormal point in the second field of view, so as to determine whether the photographed target object has an abnormal region,
wherein in response to determining that the photographed target object has the abnormal region, the unmanned aerial vehicle takes the abnormal region as a center to capture the abnormal image of the abnormal region in the second field of view,
wherein in response to determining that the photographed target object does not have the abnormal region, the unmanned aerial vehicle continually flies forward along the cruise path.

14. The unmanned aerial vehicle patrol system as claimed in claim 1, wherein in the patrol task,
in response to determining that the abnormal point is not located on any of the target objects, the unmanned aerial vehicle acquires a security image of the abnormal point that is not located on any of the target objects in the first field of view, and sends a warning notification and the security image to the base station.

15. An unmanned aerial vehicle patrol method, configured for an unmanned aerial vehicle patrol system for patrolling a target area, wherein the unmanned aerial vehicle patrol system comprises a base station and an unmanned aerial vehicle, and the target area comprises a plurality of target objects, the unmanned aerial vehicle patrol method comprising:
receiving a global positioning system signal by using the unmanned aerial vehicle to identify a coordinate position of the unmanned aerial vehicle;
receiving a patrol instruction from the base station by using the unmanned aerial vehicle to perform a patrol task to the target area, and the patrol task comprises:
acquiring a first thermal sensing image of the target area in a first field of view according to a cruise path;
determining whether there is an abnormal point in the first thermal sensing image;
in response to determining that there is the abnormal point in the first thermal sensing image by using the unmanned aerial vehicle, suspending the flight of the unmanned aerial vehicle in the cruise path, and capturing an abnormal image of the abnormal point in a second field of view, and storing and marking the abnormal image.

16. The unmanned aerial vehicle patrol method as claimed in claim 15, wherein the second field of view is smaller than the first field of view.

17. The unmanned aerial vehicle patrol method as claimed in claim 16, wherein the unmanned aerial vehicle flies along the cruise path at a first height to acquire the first thermal sensing image of the target area in the first field of view, and flies at a second height to capture the abnormal image of the abnormal point in the second field of view, wherein the first height is greater than the second height.

18. The unmanned aerial vehicle patrol method as claimed in claim 15, wherein in response to determining that there is the abnormal point in the first thermal sensing image by using the unmanned aerial vehicle, the unmanned aerial vehicle determines whether the abnormal point is located on one of the plurality of target objects according to the first thermal sensing image and the global positioning system signal, and in response to determining that the abnormal point is located on one of the plurality of target objects, the unmanned aerial vehicle suspends its flight in the cruise path, and changes to fly at the second height.

19. The unmanned aerial vehicle patrol method as claimed in claim 15, further comprising: determining that the first thermal sensing image has the abnormal point by the unmanned aerial vehicle when the unmanned aerial vehicle determines that the first thermal sensing image has a thermal image block having a temperature difference with the surrounding.

20. The unmanned aerial vehicle patrol method as claimed in claim 17, wherein the step of capturing the abnormal image of the abnormal point in the second field of view comprises:
performing an image recognition operation on a photographed target object having the abnormal point in the second field of view, so as to determine whether the photographed target object has an abnormal region; and
in response to determining that the photographed target object has the abnormal region, taking the abnormal region as a center by the unmanned aerial vehicle to capture the abnormal image of the abnormal region in the second field of view,
in response to determining that the photographed target object does not have the abnormal region, continually flying forward along the cruise path.

21. The unmanned aerial vehicle patrol method as claimed in claim 15, wherein the patrol task further comprises:
in response to determining that the abnormal point is not located on any of the target objects, acquiring a security image of the abnormal point that is not located on any of the target objects by the unmanned aerial vehicle in the first field of view, and sending a warning notification and the security image to the base station.
